(19) United States
(12) Patent Application Publication
(10) Pub. No.: US 2004/0105599 A1
(43) Pub. Date: Jun. 3, 2004

(54) Automatic identification of destination information in a facsimile transmission device

(75) Inventor: Paul A. Siddle, St. Albans (GB)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/309,582

(22) Filed: Dec. 3, 2002

(51) Int. Cl. G06K 9/20; H04N 1/00; H04N 1/32

(52) U.S. Cl. 382/317; 358/440; 358/468

(57) ABSTRACT

In a facsimile transmission device, the destination telephone number is automatically determined. The user places a mark at each of a plurality of predetermined locations on a cover sheet to indicate the destination telephone number. Each mark is placed in a numeral position of a digit area. The facsimile transmission device scans the cover sheet, electronically senses the presence of the marks, and electronically decodes the locations of the sensed marks into the destination telephone number. Decoding the sensed marks includes correlating the numeral position of the mark in each digit area with a numeral to obtain a correlated numeral for each digit of the destination telephone number.

### BACKGROUND

The present invention relates to document facsimile transmission devices, and in particular to entering transmission destination information.

Most document facsimile transmission devices require a human user to manually enter on a keypad the telephone number of the destination facsimile device to which the user wishes to transmit the document. Often, the user has written or printed this destination telephone number on the face of the document to be transmitted. However, many facsimile transmission devices are configured in such a way that the user inserts the document to be transmitted face-down. Therefore, the user must remember the destination telephone number, or write the number on a separate piece of paper or on the back of the document to be transmitted.

### SUMMARY

The present invention provides automatic identification of the destination telephone number in a facsimile transmission device. In accordance of an aspect of the present invention, the facsimile transmission device obtains an electronic representation of a document. The facsimile transmission device senses in the electronic representation of the document electronic data indicating the presence of marks at predetermined positions on the document, and converting the positions of the sensed marks into a destination telephone number. After receiving an instruction to contact the destination facsimile device, the facsimile transmission device automatically attempts to contact the destination telephone number by dialing the destination telephone number.

In accordance with the another aspect of the present invention, a facsimile transmission device includes a document scanner for scanning a document, and a decoder connected to the document scanner. The decoder senses the presence of marks at predetermined locations on the scanned document, and determines from the locations of the sensed marks on the scanned document a destination telephone number. The facsimile transmission device also includes a dialer for automatically dialing the identified destination telephone number.

### FIGURES

FIG. 1 is a perspective view of a representative document facsimile transmission device incorporating an aspect of the present invention.

FIG. 2 is a cross-sectional side view of the facsimile transmission device of FIG. 1.

FIG. 3 illustrates a representative implementation of the face of a document cover sheet for a facsimile transmission.

FIG. 4 illustrates a second representative implementation of the face of a document cover sheet for a facsimile transmission.

FIG. 5 illustrates a third representative implementation of the face of a document cover sheet for a facsimile transmission.

FIG. 6 illustrates a fourth representative implementation of the face of a document cover sheet for a facsimile transmission.

FIG. 7 illustrates a fifth representative implementation of the face of a document cover sheet for a facsimile transmission.

FIG. 8 illustrates a sixth representative implementation of the face of a document cover sheet for a facsimile transmission.

### DETAILED DESCRIPTION

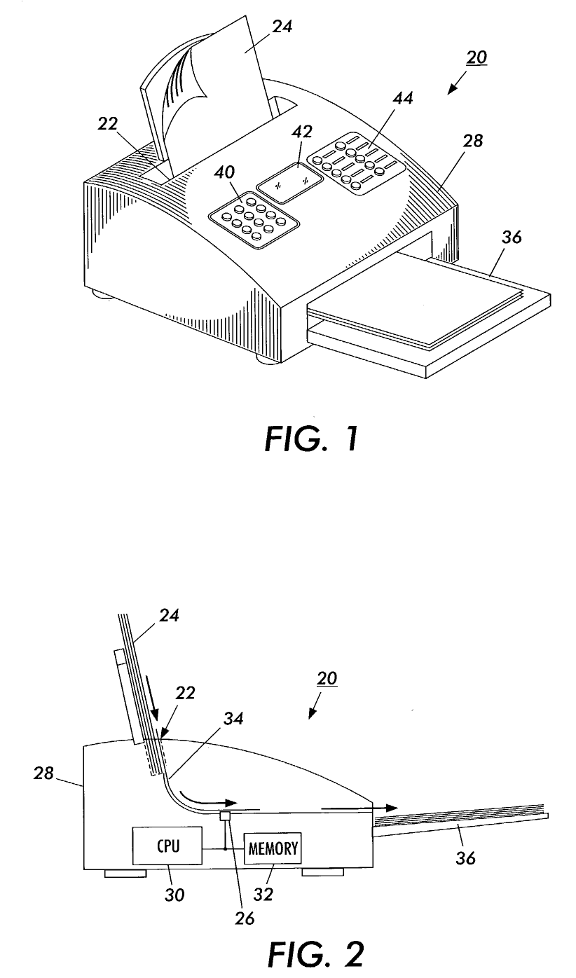

Document facsimile transmission devices are generally well understood. FIGS. 1 and 2 illustrate generally a document facsimile transmission device 20 implementing the present invention. The facsimile device receives at a document input 22 a document 24 to be transmitted. The document is usually (printed on paper). The facsimile device scans the document with a scanner 26 to generate an electronic representation of the document, and transmits the electronic representation of the document to a destination facsimile device (not shown). The transmission process generally includes converting the electronic representation of the document into an analog signal, and transmitting that signal over the telephone system.

The facsimile device includes a housing 28 that encloses many of the working components, such as the document scanner 26 (FIG. 2), a central processing unit (CPU) 30, and device memory 32. The facsimile device may also include a printer element (not shown). A document input 22, such as a document input tray, receives the document 24 to be scanned and transmitted. In operation, the facsimile device draws the document 24 along a paper path 34, past the scanner 26, and to an output tray 36. The scanner 26 scans the document to generate the electronic representation of that document. The facsimile device 20 includes a user interface on the exterior of the housing 28 for providing information to the user, and for the user to instruct the facsimile device. The user interface includes a keypad 40 for the user to input information, such as the telephone number of the destination facsimile device. A display screen 42 provides graphical or text information to the user. Other buttons or switches 44 may have specific defined purposes.

The CPU 30 is connected to the scanner 26 to receive at least some of the electronic representations of the documents scanned by the scanner. The scanner may deliver the electronic representation of the documents to the memory 32. Therefore, the CPU 30 may receive the electronic representation of the documents directly from the scanner 26, or from the memory 32. The CPU may be a software controlled general purpose microprocessor. The CPU may also be configured to perform other functions of the facsimile device. In other implementations, the CPU may be a special purpose device for performing the particular tasks described herein, and other control mechanisms may be provided to perform other functions in the facsimile device.

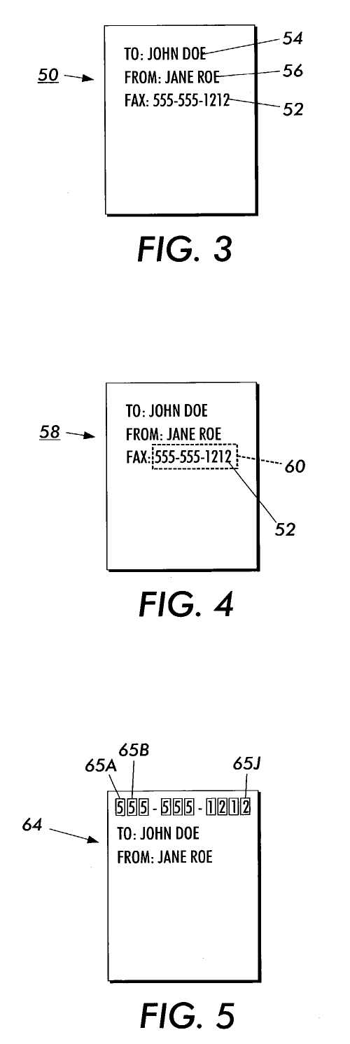

The user of the facsimile transmission device completes a cover sheet that includes destination information, such as the telephone number of the intended destination facsimile device. One example of a cover sheet is shown in FIG. 3. The user completes the cover sheet 50 by handwriting, using for example a pen or pencil, by typing with a typewriter, or by inputting the information into a computer, and printing the completed cover sheet. The user marks the cover sheet 50 with the telephone number 52 of the destination facsimile device. The user may include additional information on the cover sheet, such as the recipient's name 54, the sender's name 56, and other information. The user inserts the cover sheet and the other pages of the document to be transmitted into the document input 22. The facsimile device draws the cover sheet (and the other pages of the document in sequence) past the scanner 26. The scanner scans the document to generate an electronic representation of the document (including the cover sheet). The electronic representation of at least the cover sheet is stored in the memory 32 and/or conveyed directly to the CPU 30.

The CPU analyzes the electronic representation of the scanned document (cover sheet 50) to identify destination information, such as the telephone number of the intended destination facsimile device. Because users typically place this information on the cover sheet, and the cover sheet is typically the first sheet of a document, the CPU may be configured to analyze only the first page of a multi-page document scanned by the scanner. In certain applications, the facsimile device may receive the document directly in electronic form, bypassing the step of scanning a paper document with the scanner. For example, the document (including the cover sheet) may exist in electronic form in a computer, and be transferred in electronic form directly to the memory 32 or the CPU 30 of the facsimile device.

In analyzing the electronic representation of the cover sheet, the CPU identifies data that may or is likely to be the relevant destination information. For example, in analyzing the electronic representation of the scanned cover sheet 50 of FIG. 3 to obtain the destination facsimile telephone number 52, the CPU identifies data likely to represent a telephone number. The CPU uses optical character recognition to identify a string of a certain number of numerals, such as seven or more numerals. Various techniques of optical character recognition are known to those skilled in the art, and are available from several sources. To simplify processing, the CPU can be configured or programmed to identify only numerals, which is generally a simpler character recognition task than identifying letters. In another configuration, the CPU can be configured or programmed to identify a known set of characters or other elements that indicate the presence of the destination telephone number, and then examine an adjacent specific area of the cover sheet. For example, the CPU may identify the word “FAX” or “FAX NO.” as an indicator that an adjacent string of numbers is the destination telephone number, and then examine the adjacent are for numerical characters. This reduces the possibility that the CPU will incorrectly identify other numbers on the page as the destination telephone number.

A different version of a facsimile cover sheet 58 is shown in FIG. 4. FIG. 4 shows symbolically a region 60 of the cover sheet in which the user writes the destination telephone number 52. The CPU is configured to examine only this region 60 of the cover sheet by analyzing the data representing this region to identify the relevant destination information. Reducing the amount of the cover sheet the CPU examines reduces the processing activity required, and avoids the CPU incorrectly identifying other numbers on the cover sheet 58 (such as voice telephone numbers, the sender's telephone number, etc.) as the destination facsimile telephone number 52. The owner of the facsimile transmission device can select the region 60 of the cover sheet the CPU examines for the destination facsimile telephone number. The facsimile owner can then prepare a template facsimile cover sheet for all users of that facsimile device to use. The template provides a mechanism for the users to properly place the destination facsimile device telephone number in the region of the cover sheet that will be examined by the CPU.

FIG. 5 shows a version of a facsimile cover sheet 64 in which a separate digit region 65a-65j on the sheet is provided for each individual digit of the destination facsimile device telephone number. The CPU examines each region for a single digit, using optical character recognition to determine the numerical character in that region.

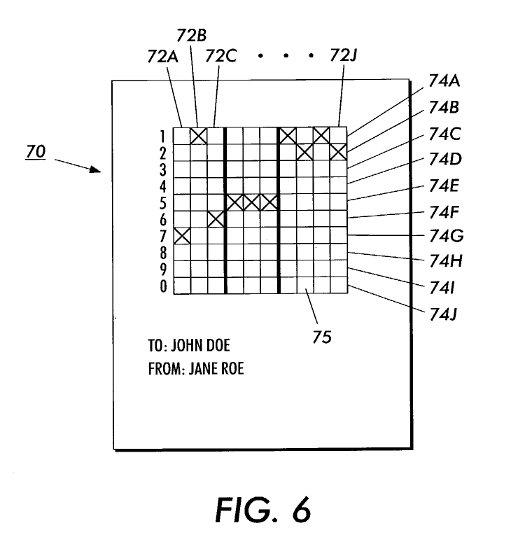

The CPU 30 of the facsimile device can be configured or programmed to identify the destination information (such as the destination facsimile device telephone number) without using optical character recognition. FIG. 6 shows a version of a facsimile cover sheet 70 on which the user places a mark at a particular location on the sheet to designate a particular numerical value for a particular digit of the destination facsimile telephone number. Each designated location is associated with no more than one numerical value for one digit of the destination telephone number.

Therefore, when the CPU senses a mark at a particular designated location, the CPU is able to convert that sensed mark into a numerical value for a particular digit of the telephone number. By accumulating the converted marks, the CPU decodes the marks on the cover sheet into the complete destination telephone number.

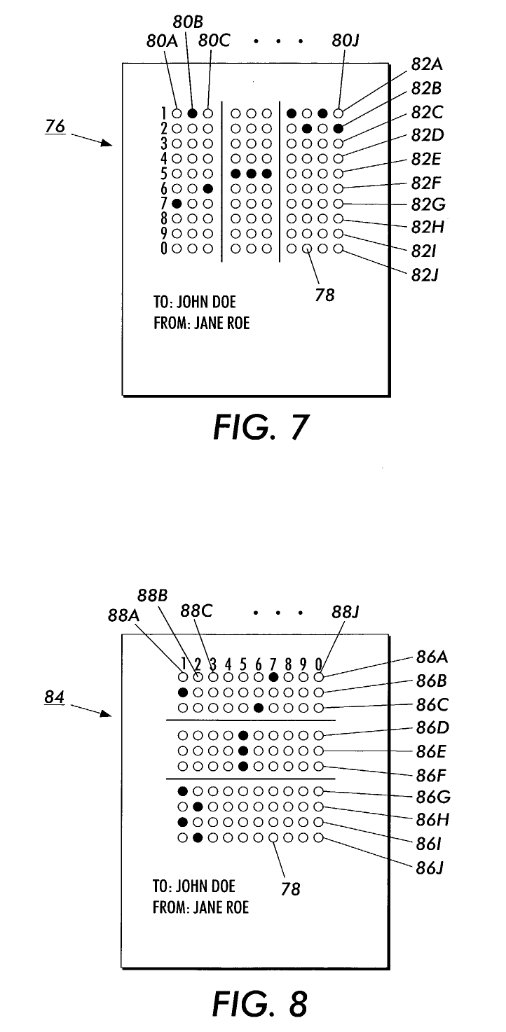

The particular cover sheet implementation shown in FIG. 6 is configured with locations for numerical values in each digit spot of a ten-digit telephone number, such as are commonly used in the United States. After reading this description, those skilled in the art will recognize how to prepare other configurations for other number arrangements. The cover sheet implementation of FIG. 6 has ten digit areas 72a-72j (one for each digit of the telephone number), with ten numeral positions 74a-74j in each digit area (one for each possible numeral for that digit). The illustrated cover sheet has been marked for the telephone number 716-555-1212 by placing a mark in the seventh numeral position 74g of the first digit area 72a, the first numeral position 74a of the second digit area 72b, the sixth numeral position 74f of the third digit area 72c, and so forth. Each numeral position of each digit area is illustrated as a box 75 identifying a location on the cover sheet, and the mark is shown as a cross or “x.” However, other arrangements and marks can be used. For example, FIG. 7 shows a cover sheet 76 having a “bubble” 78 at each numeral position 82a-82j of each digit area 80a-80j. The destination telephone number is marked by filling in the bubbles at the appropriate numeral position 82a-82j of each digit area 80a-80j. The exemplary cover sheets of FIGS. 6 and 7 have the digit areas 80a-80j as columns. FIG. 8 shows an implementation of a cover sheet 84 in which the digit areas 86a-86j are oriented horizontally, in rows, and the numeral positions 88a-88j are oriented vertically, in columns. Other configurations are possible to create a sheet area in which a designated location on the cover sheet (such as a bubble 78) is associated with no more than one numerical value for a single digit of the telephone number.

After the scanner 26 (FIG. 2) scans this cover sheet, the CPU 30 examines the representation to sense which area 75, 78 representing a numeral position 74, 82, 88 in each digit area 72, 80, 86 has a mark. For example, the CPU analyzes the electronic representation of the cover sheet of FIG. 6 to sense that there is a mark in the location on the sheet corresponding to the seventh numeral position 74g in the first digit area 72a. The CPU also senses that there is a mark in the location on the sheet corresponding to the first numeral position 74a in the second digit area 72b, another mark in the sixth numeral position 74f in the third digit area 72c, and so forth.

The CPU can be configured or programmed to determine if the decoded destination telephone number is sufficient to initiate the call. For example, the CPU can be programmed to determine if the decoded number has a proper number of digits—such as 4 or 5 digits indicating an internal plant number, 7 digits indicating an external local telephone number, 10 digits for a long distance in-country call, etc. The CPU can also be programmed to identify certain indications of an error in decoding the destination telephone number. For example, in some telephone systems, a “0” or “1” as the first digit might be an indication that the destination telephone number was not correctly decoded. In such instances, the CPU can cause the screen of the user interface to display to the user an error message.

If the CPU determines that it appears to have sufficient information to initiate the call, the CPU causes the facsimile transmission device to dial the destination telephone number decoded from the data on the cover sheet. The CPU may control the dialing process, or it may instruct another element of the facsimile device to do so. The dialing process may be undertaken immediately after the destination telephone number is decoded, with the CPU issuing a “start transmission” instruction, or the process may be delayed until a “start transmission” instruction is received from another element or device, or from another portion of the CPU. For example, the CPU may be programmed to provide a delayed transmission arrangement, such as is common in facsimile devices.

The CPU can be programmed to perform the dialing process in accordance with local telephone requirements. The CPU can be programmed to identify the number of digits in the decoded destination telephone number to determine if the destination telephone number is in plant or external. The CPU can be programmed so that if it determines that the destination telephone number requires a telephone line access number to precede the telephone number, such as if the call is external, the CPU automatically precedes the dialing of the decoded destination telephone number with a “9” or other telephone line access requirement in accordance with local telephone system requirements. In addition, when the CPU detects that the decoded destination telephone number requires a long distance dialing element, such as a “1” preceding the destination telephone number, the CPU can automatically insert such dialing elements. Furthermore, the CPU can be programmed to add automatically at the end of the dialing sequence control codes or authorization numbers that may be required in the telephone system to complete, for example, long distance calls. If different users of the facsimile device have different authorization numbers, the cover sheet can be designed to also provide a grid of locations at which the user can place marks indicating the numerical values of the digits of the authorization numbers. The CPU can be programmed to sense these marks also, and to decode the locations of the marks to determine the authorization code. The CPU can then instruct the facsimile device to dial that authorization code at the appropriate point in the dialing sequence.

Particular implementations of processes and devices have been described and shown above. After reading the present description, those skilled in the art will recognize that various modifications to those particular implementations are possible without departing from the spirit of the invention. For example, other arrangements of the digit spaces and numeral positions can be created, as can numerous variations on the physical configuration of the facsimile device. Therefore, the invention is not limited to the particular implementations described and shown above.

I claim:

1. In a document facsimile transmission device, a method of conducting a transmission, the method comprising:
placing a mark at each of a plurality of predetermined locations on a document to indicate a destination telephone number;
electronically scanning the document;
electronically sensing the presence of the marks at the predetermined locations on the document;
electronically decoding the locations of the sensed marks on the document into the destination telephone number; and
in response to a transmit instruction, automatically dialing the decoded destination telephone number.

2. The method of claim 1, wherein sensing the presence of marks comprises:
sensing a first mark in a first digit area of the document;
sensing a second mark in a second digit area of the document; and
sensing a third mark in a third digit area of the document.

3. The method of claim 2, wherein electronically decoding the locations of the sensed marks comprises:
determining a first numeral position of the first mark in the first digit area;
correlating the first numeral position with a correlated numeral to establish a first correlated numeral;
recording the first correlated numeral as a first digit of the destination telephone number;
determining a second numeral position of the second mark in the second digit area;
correlating the second numeral position with a correlated numeral to establish a second correlated numeral;
recording the second correlated numeral as a second digit of the destination telephone number;
determining a third numeral position of the third mark in the third digit area;
correlating the third numeral position with a correlated numeral to establish a first correlated numeral;
recording the third correlated numeral as a third digit of the destination telephone number.

4. The method of claim 1, wherein placing a mark at each of a plurality of predetermined locations comprises:
placing a first mark in one of ten numeral positions in a first digit area to indicate a first digit of the recipient telephone number;
placing a second mark in one of ten numeral positions in a second digit area to indicate a second digit of the recipient telephone number; and
placing a third mark in one of ten numeral positions in a third digit area to indicate a third digit of the destination telephone number.

5. The method of claim 1, wherein:
placing a mark at each of a plurality of predetermined locations on a document comprises placing first through seventh marks in first through seventh digit areas of the document;
sensing the presence of the marks comprises sensing the presence of the first through seventh marks;
decoding comprises identifying the position of each of the first through seventh marks in each of the first through seventh digit areas;
correlating the position of each mark with a numeral to produce first through seventh correlated numerals;
recording the first through seventh correlated numerals as first through seventh digits of the decoded destination telephone number.

6. In a facsimile transmission device, a method of initiating a transmission, the method comprising:
obtaining an electronic representation of a document;
sensing in the electronic representation of the document electronic data indicating the presence of marks at predetermined locations on the document;
converting the locations of the sensed marks into a destination telephone number;
responsive to an instruction to contact the recipient, automatically calling the destination telephone number.

7. The method of claim 6, wherein obtaining an electronic representation of a document comprises electronically scanning the document.

8. The method of claim 6, additionally comprising determining if the converted destination telephone number contains no indicators of an error, and performing the automatic calling step only if converted destination telephone number contains no indicators of an error.

9. A facsimile transmission device comprising:
a document scanner for scanning a document;
a decoder connected to the document scanner, wherein the decoder senses the presence of marks at predetermined locations on the scanned document, and determines from the locations of the sensed marks on the scanned document a destination telephone number; and
a dialer for automatically dialing the identified recipient telephone number.
